(19) United States
(12) Patent Application Publication
(10) Pub. No.: US 2002/0101315 A1
(43) Pub. Date: Aug. 1, 2002

(54) Ignition coil with primary winding release

(76) Inventors: Colin Hamer, Noblesville, IN (US); Mark Albert Paul, Fishers, IN (US)

Correspondence Address: MARGARET A. DOBROWITSKY, DELPHI TECHNOLOGIES, INC., Legal Staff Mail Code: 480-414-420, P.O. Box 5052, Troy, MI, 48007-5052, US

(21) Appl. No.: 09/773,099

(22) Filed: Jan. 31, 2001

(51) Int. Cl. H01F 27/02

(52) U.S. Cl. 336/90

(57) ABSTRACT

An ignition apparatus includes a central core, a primary winding, a secondary winding wound on a secondary winding spool, a case and a shield. The primary winding is covered with a release layer comprising one of PTFE, polyamide, polyester or silicone rubber material. The release layer is configured to demote adhesion of an encapsulant disposed between the release layer and an inside diameter of the secondary winding spool. The encapsulant adheres more consistently and completely to the secondary winding spool reducing localized stresses on the spool which otherwise cause cracking or the like to occur.

### BACKGROUND OF THE INVENTION

1. Technical Field

The present invention relates generally to ignition coils for developing a spark firing voltage that is applied to one or more spark plugs of an internal combustion engine.

2. Discussion of the Background Art

Ignition coils utilize primary and secondary windings and a magnetic circuit. The magnetic circuit may include a magnetically-permeable central core, as disclosed in U.S. Pat. No. 5,870,012 to Sakamaki et al. Sakamaki et al. disclose an ignition coil having a relatively slender configuration adapted for mounting directly above a spark plug—commonly referred to as a “pencil” coil. The ignition coil of Sakamaki et al. has a core composed of laminations of iron plates nearly circular in radial cross-section. Sakamaki et al. further disclose a primary bobbin disposed radially outwardly of the core having a primary coil wound thereon, a secondary bobbin disposed radially outwardly of the primary coil having a secondary coil wound thereon, and a case disposed outwardly of the secondary coil. Sakamaki et al. further disclose that melted insulating resin is introduced into the space between the primary bobbin and the secondary bobbin such that the two bobbins are fixed to each other with the resin layer formed therebetween.

Multiple problems, however, arise from a configuration of the type disclosed in Sakamaki et al. One problem arises out of design and manufacturing process tolerances (i.e., dimension) of the space between the primary winding and the inside of the secondary spool. For example, the number of layers of primary wire may affect the radial distance between the outside of the primary winding and the secondary spool in a nonuniform way at various points taken in an axial direction along the primary winding. It is desirable to have uniform, homogenous adhesion of the encapsulant (e.g., the resin of Sakamaki et al.) to the inside of the secondary spool. However, shrinkage effects, which occur as a function of thickness, among other factors, leads to large and varying areas of the encapsulant to exhibit varying adhesion to the secondary spool. In addition, the surface of the primary winding presents a less than wholly uniform surface, which may also contribute to the above-mentioned irregularities in shrinkage by introducing variations in encapsulant thickness. Moreover, during operation, thermal effects may operate such that stresses are applied to both sides of the encapsulant (i.e., the spool side, and primary winding side). The inconsistent levels of adhesion to the secondary spool leads to areas of local residual and thermal-mechanical stresses during operation. These stresses result in a reduction in the service life of the ignition coil because of electrical failure, due to cracking of the bobbin (i.e., spool) material. Controlling shrinkage is expensive and in some cases impractical or difficult to control.

An approach taken in the art pertaining to the above-mentioned problem is disclosed in U.S. Pat. No. 5,923,236 to Rapoport et al. Rapoport et al. disclose (i) matching a housing material to an epoxy potting compound with respect to coefficient of thermal expansion, as well as (ii) plasma cleaning all components that contact the epoxy in order to promote adhesion of the epoxy to the cleaned components. The foregoing approach, however, increases the complexity of the manufacturing process as well as material costs.

There is therefore a need to provide an improved ignition apparatus that minimizes or eliminates one or more of the shortcomings as set forth above.

### SUMMARY OF THE INVENTION

An object of the present invention is to solve one or more of the problems as set forth above. An ignition apparatus according to the present invention overcomes shortcomings in the art by demoting adhesion to the outside diameter portion of the primary winding, thereby effectively managing stresses that may otherwise occur at the interface between the inside diameter of the spool and the encapsulant. Through the foregoing, the encapsulant will favor the inside of the secondary spool during cure, resulting in a substantially reduced or eliminated residual stress at the secondary spool/encapsulant interface. During operation, for example, during thermal cycling, the interface stress will be substantially unidirectional (i.e., toward the spool) and minimized, compared to conventional approaches, where adhesion of the encapsulant occurs on both interfaces (i.e., the secondary spool/encapsulant interface, and the encapsulant/primary winding interface). The foregoing provides improved durability by reducing stresses that may result in a cracked secondary spool. The invention accomplishes this by better absorbing manufacturing tolerances and design limitations.

An ignition apparatus includes a central core, a primary winding outwardly of the core, a secondary winding on a secondary winding spool outwardly of the primary winding, a case, and a shield. According to the invention, a release material is applied to and is disposed outwardly of the primary winding and is configured to demote adhesion of an encapsulant such as an epoxy potting material disposed between the release material and the inside surface of the secondary winding spool.

### BRIEF DESCRIPTION OF THE DRAWINGS

The present invention will now be described by way of example, with reference to the accompanying drawings, in which:

FIG. 1 is a simplified, cross-section view of an ignition apparatus in accordance with the present invention;

FIG. 2 is an enlarged view of a portion of the ignition apparatus of FIG. 1; and

FIG. 3 is an exaggerated cross-section view of FIG. 2 taken substantially along lines 3-3.

### DETAILED DESCRIPTION OF THE PREFERRED EMBODIMENTS

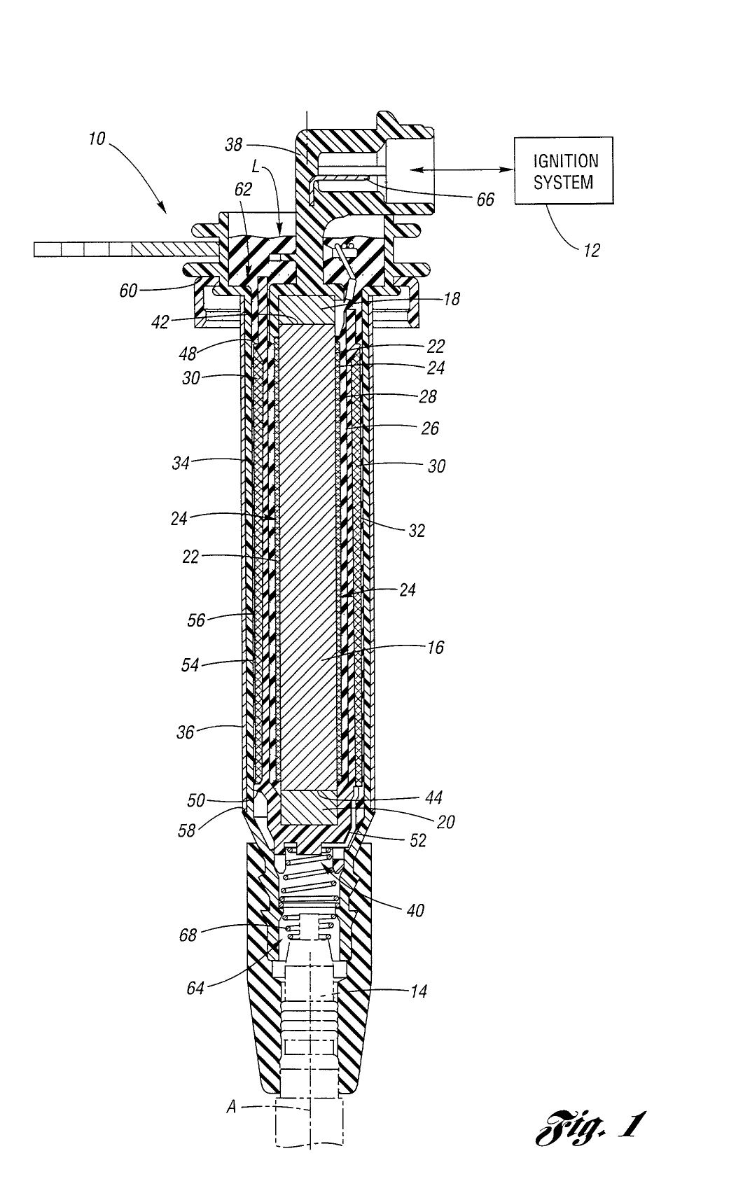

Referring now to the drawings wherein like reference numerals are used to identify identical components in the various views, FIG. 1 is a simplified, cross-section view of an ignition apparatus 10 in accordance with the present invention. As is generally known, ignition apparatus 10 may be coupled to, for example, an ignition system 12, which contains primary energization circuitry for controlling the charging and discharging of ignition apparatus 10. Further, also as is well known, the relatively high voltage produced by ignition apparatus 10 is provided to a spark plug 14 (shown in phantom-line format) for producing a spark across a spark gap thereof, which may be employed to initiate combustion in a combustion chamber of an engine. Ignition system 12 and spark plug 14 perform conventional functions well known to those of ordinary skill in the art.

Ignition apparatus 10 is adapted for installation to a conventional internal combustion engine through a spark plug well onto a high-voltage terminal of spark plug 14, which may be retained by a threaded engagement with a spark plug opening into the above-described combustion cylinder. The engine may provide power for locomotion of a vehicle, as known. Ignition apparatus 10 comprises a substantially slender high voltage transformer including substantially, coaxially arranged primary and secondary windings and a high permeability magnetic core.

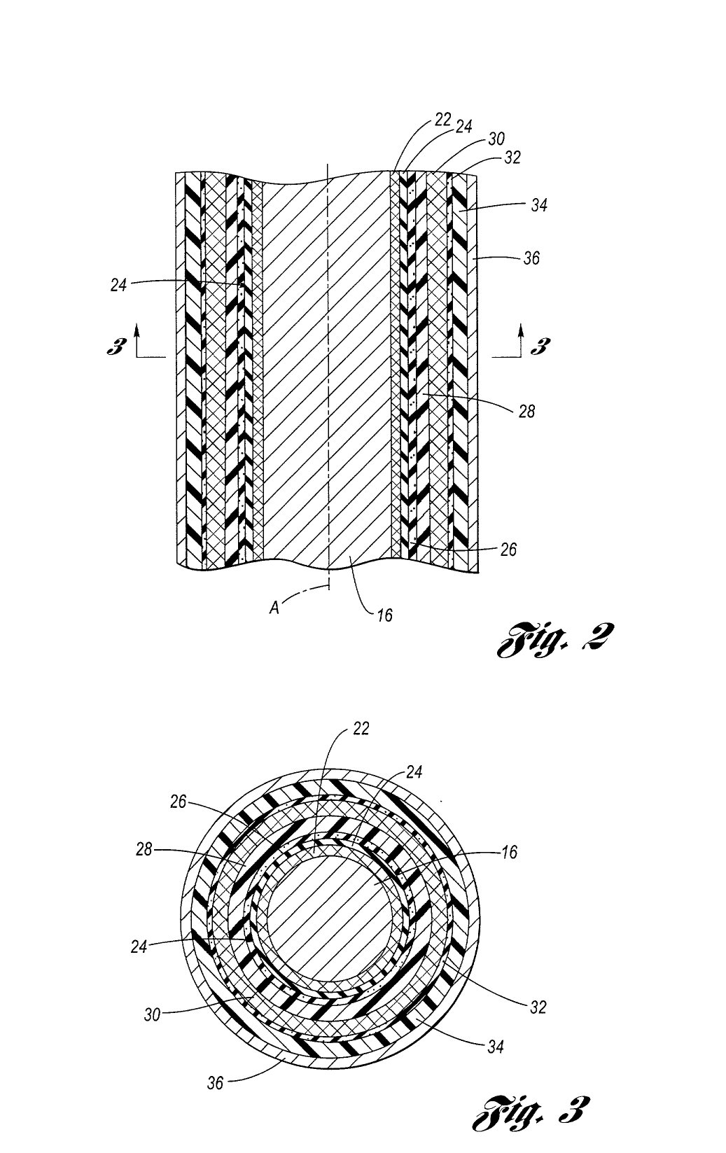

FIG. 1 further shows a core 16, a first magnet 18, a second magnet 20, a primary winding 22, a layer of release material 24 (best shown in FIG. 2), a first layer of encapsulant such as an epoxy potting material layer 26, a secondary winding spool 28, a secondary winding 30, a second layer of encapsulant such as a second epoxy potting material layer 32, a case 34, a shield 36, a low-voltage (LV) connector body 38, and a high-voltage (HV) connector assembly 40.

FIG. 2 shows release layer 24 in greater detail. Layer 24, as shown, is disposed directly on primary winding 22. The layer 24 is configured principally to demote adhesion of encapsulant thereto so as to effectively promote more uniform adhesion of the encapsulant material to an inner surface of secondary winding spool 28. Layer 24, accordingly, may comprise a plurality of materials described below.

For example, layer 24 may comprise P.T.F.E. material, such a TEFLON® brand tape, or polyamide material, such as polyamide tape. In the alternative, layer 24 may comprise a polyester film, such as MYLAR® tape or a MYLAR® shrink tube, both commercially available from E. I. du Pont de Nemours and Company, Wilmington, Del., United States. As a further alternative, layer 24 may comprise a silicone gel coating, and may be applied by dipping. As a still further alternative, layer 24 may comprise a silicone rubber LIM sleeve. Layer 24 may be relatively thin, for example, down to about one layer of tape when PTFE or polyamide tape is used (e.g., may have a thickness down to less than 3 mils—0.075 mm—and up). The function of release layer 24 is principally functional—to demote adhesion by providing a surface that does not chemically bond with the encapsulant (or bond very well).

It should be understood, however, that the thickness information set forth above is exemplary rather than limiting in nature. The thickness set forth above has been found satisfactory based on the materials described above. Other materials may have different properties requiring a greater or diminished thickness in order to achieve the function of demoting adhesion with any particular encapsulant, such as an epoxy potting material.

As described herein, the advantage of layer 24 is that it demotes adhesion of encapsulant material to the outside of primary winding 22. This minimizes interface stresses at the inner surface of secondary winding spool 28, since the encapsulant material favors the secondary winding spools during the gel and cure processes. After cure, and during thermal cycling (i.e., during operation), any interface stress will be unidirectional (i.e., radially outwardly toward the spool and not toward the release material layer 24/primary winding 22). This reduces areas of heightened local residual and thermal-mechanical stress, compared to conventional configurations where there is adhesion of the encapsulant to both surfaces (i.e., primary winding and secondary winding spool). Minimizing or eliminating these stresses improve durability, since secondary spool cracking or breakdown is avoided or minimized.

Layer 24 may be directly disposed on primary winding 22. This may be accomplished by wrapping (e.g., if the layer 24 comprises PTFE, polyamide or other type of tape). Alternatively, layer 24 may be formed by dipping the core 16/winding 22 combination into a silicone gel coating material so as to coat the combination, and then allowing the material to cure in accordance with the manufacturer's instructions. As a further alternative, if the layer 24 is a “shrink tube,” then the heat sensitive tubing material is first disposed over the core 16/winding 22 combination, then this assembly is heated so that the tubing “shrinks” and conforms to the outer periphery of primary winding 22. If layer 24 comprises a sleeve (e.g., silicone rubber LIM sleeve), then the sleeve (i.e., preformed) is fitted over the core/winding assembly until it is suitably covered. The foregoing approaches are exemplary, and not limiting in nature.

Other known manufacturing steps are next performed. For example, the secondary spool 28 having the secondary winding 30 is disposed outwardly of the core 16/primary winding 22/layer 24 assembly. Other steps may be further performed, such as assembling magnets 18/20, and LV connector body 38. The case 34/shield 36 is disposed outwardly of the foregoing central components. This is commonly done by inserting the central components (e.g., preassembled, which may also include LV connector body 38) through bore 62 in a manner known to those of ordinary skill in the art. Other approaches, however, are known.

Finally, the apparatus 10 is potted, and all other details of the manufacture are attended to, also as known generally in the art using a known encapsulant, for example, an epoxy potting material. As described above, the encapsulant adheres to the inside of the secondary winding spool 28 in favor of the release layer 24.

Referring again to FIG. 1, further details concerning an exemplary ignition apparatus 10 will now be set forth. It should be understood that the following is exemplary only and not limiting in nature. Many other configurations are known to those of ordinary skill in the art and are consistent with the teachings of the present invention. Core 16 may be elongated, having a main, longitudinal axis “A” associated therewith. Core 16 includes an upper, first end 42, and a lower, second end 44. Core 16 may be a conventional core known to those of ordinary skill in the art. As illustrated, core 16, in the preferred embodiment, takes a generally cylindrical shape (which is a generally circular shape in radial cross-section), and may comprise compression molded insulated iron particles.

Magnets 18 and 20 are included in ignition apparatus 10 as part of the magnetic circuit, and provide a magnetic bias for improved performance. The construction of magnets such as magnets 18 and 20, as well as their use and effect on performance, is well understood by those of ordinary skill in the art. It should be understood that magnets 18 and 20 are optional in ignition apparatus 10, and may be omitted, albeit with a reduced level of performance, which may be acceptable, depending on performance requirements.

Primary winding 22 may be wound directly onto core 16 in a manner known in the art. Primary winding 22 includes first and second ends and is configured to carry a primary current Iₚ for charging apparatus 10 upon control of ignition system 12. Winding 22 may be implemented using known approaches and conventional materials. Although not shown, primary winding 22 may be wound on a primary winding spool (not shown).

Layers 26 and 32 comprise an encapsulant suitable for providing electrical insulation within ignition apparatus 10. In a preferred embodiment, the encapsulant comprises epoxy potting material. The epoxy potting material introduced in layers 26, and 32 may be introduced into annular potting channels defined (i) between release layer 24 and secondary winding spool 28, and, (ii) between secondary winding 30 and case 34. The potting channels are filled with potting material, in the illustrated embodiment, up to approximately the level designated “L” in FIG. 1. In one embodiment, layer 26 may be between about 0.1 mm and 1.0 mm thick. Layer 26 thicknesses less than about 0.1 mm begin to present challenges respecting the flow of the encapsulant (i.e., effectively filling voids). Of course, a variety of other thicknesses are possible depending on flow characteristics and insulating characteristics of the encapsulant. It should be understood, however, that the shrinkage of conventional encapsulants occurs as a function of volume. Accordingly, a reduction in volume results in a corresponding reduction in shrinkage, which results in reduced stress. The potting material also provides protection from environmental factors which may be encountered during the service life of ignition apparatus 10. There are a number of suitable epoxy potting materials well known to those of ordinary skill in the art.

Secondary winding spool 28 is configured to receive and retain secondary winding 30. Spool 28 is disposed adjacent to and radially outwardly of the central components comprising core 16, primary winding 22, release layer 24, and epoxy potting layer 26, and, preferably, is in coaxial relationship therewith. Spool 28 may comprise any one of a number of conventional spool configurations known to those of ordinary skill in the art. In the illustrated embodiment, spool 28 is configured to receive one continuous secondary winding (e.g., progressive winding), as is known. However, it should be understood that other configurations may be employed, such as, for example only, a configuration adapted for use with a segmented winding strategy (e.g., a spool of the type having a plurality of axially spaced ribs forming a plurality of channels therebetween for accepting windings) as known.

The depth of the secondary winding in the illustrated embodiment decreases from the top of spool 28 (i.e., near the upper end 42 of core 16), to the other end of spool 28 (i.e., near the lower end 44) by way of a progressive gradual flare of the spool body. The result of the flare or taper is to increase the radial distance (i.e., taken with respect to axis “A”) between primary winding 22 and secondary winding 30, progressively, from the top to the bottom. As is known in the art, the voltage gradient in the axial direction, which increases toward the spark plug end (i.e., high voltage end) of the secondary winding, may require increased dielectric insulation between the secondary and primary windings, and, may be provided for by way of the progressively increased separation between the secondary and primary windings.

Spool 28 is formed generally of electrical insulating material having properties suitable for use in a relatively high temperature environment. For example, spool 28 may comprise plastic material such as PPO/PS (e.g., NORYL available from General Electric) or polybutylene terephthalate (PBT) thermoplastic polyester. It should be understood that there are a variety of alternative materials which may be used for spool 28 known to those of ordinary skill in the ignition art, the foregoing being exemplary only and not limiting in nature.

Spool 28 may further include a first annular feature 48 and a second annular feature 50 formed at axially opposite ends thereof. Features 48 and 50 may be configured so as to engage an inner surface of case 34 to locate, align, and center the spool 28 in the cavity of case 34.

In addition, the body portion of spool 28 tapers on a lower end thereof to a reduced diameter, generally cylindrical outer surface sized to provide an interference fit with respect to a corresponding through-aperture at the lower end of case 34. In addition, the spool body includes a blind bore or well at the spark plug end configured in size and shape to accommodate the size and shape of HV connector assembly 40. In connection with this function, spool 28 may be formed having an electrically conductive (i.e., metal) high-voltage (HV) terminal 52 disposed therein configured to connect a high voltage lead of secondary winding 30 to the HV connector assembly 40.

FIG. 1 shows secondary winding 30. Secondary winding 30, as described above, is wound on spool 28, and includes a low voltage end and a high voltage end. The low voltage end may be connected to ground by way of a ground connection through LV connector body 38 in a manner known to those of ordinary skill in the art. The high voltage end is connected to the above-described (HV) terminal 52 for electrically connecting the high voltage generated by secondary winding 30 to HV connector assembly 40 for firing spark plug 14. As known, an interruption of a primary current Iₚ through primary winding 22, as controlled by ignition system 12, is operative to produce a high voltage at the high voltage end of secondary winding 30. Winding 30 may be implemented using conventional approaches and material known to those of ordinary skill in the art.

Case 34 includes an inner, generally cylindrical surface 54, an outer surface 56, a first annular shoulder 58, a flange 60, an upper through-bore 62, and a lower through bore 64.

Inner surface 54 is configured in size to receive and retain the core 16/primary winding 22/spool 28/secondary winding 30 assembly. The inner surface 54 of case 34 may be slightly spaced from spool 28, particularly the annular spacing features 48, 50 thereof (as shown), or may engage the spacing features 48, 50.

Annular shoulder 58, and flange 60 are located near the lower, and upper ends of case 34, respectively. Shoulder 58 is formed in size and shape to engage and support a bottommost circumferential edge of shield 36. Likewise, flange 60 is configured in size and shape to engage and support an uppermost circumferential edge of shield 36.

Bore 62 is configured in size and shape to receive the combined assembly of core 16/primary winding 22/spool 28/secondary winding 30.

Bore 64 is defined by an inner surface thereof configured in size and shape (i.e., generally cylindrical) to provide an interference fit with an outer surface of spool body 28 (i.e., a lowermost portion thereof), as described above. When the lowermost body portion of spool 28 is inserted in bore 64, therefore, a seal is made.

Case 34 is formed of electrical insulating material, and may comprise conventional materials known to those of ordinary skill in the art (e.g., the PBT thermoplastic polyester material referred to above).

Shield 36 is generally annular in shape and is disposed radially outwardly of case 34, and, preferably, engages outer surface 56 of case 34. The shield 36 is preferably comprises electrically conductive material, and, more preferably metal, such as silicon steel or other adequate magnetic material. Shield 36 provides not only a protective barrier for ignition apparatus 10 generally, but, further, provides a magnetic path for the magnetic circuit portion of ignition apparatus 10. Shield 36 may nominally be about 0.50 mm thick, in one embodiment. Shield 36 may be grounded by way of an internal grounding strap, finger or the like (not shown) well know to those of ordinary skill in the art. Shield 36 may comprise, as illustrated, multiple, individual sheets 36.

Low voltage connector body 38 is configured to, among other things, electrically connect the first and second ends of primary winding 22 to an energization source, such as, the energization circuitry included in ignition system 12. Connector body 38 is generally formed of electrical insulating material, but also includes a plurality of electrically conductive output terminals 66 (e.g., pins for ground, primary winding leads, etc.). Terminals 66 are coupled electrically, internally through connector body 38, in a manner known to those of ordinary skill in the art, and are thereafter connected to various parts of apparatus 10, also in a manner generally know to those of ordinary skill in the art. Ignition system 12 may then control energization of the primary winding 22.

HV connector assembly 40 may include a spring contact 68 or the like, which is electrically coupled to HV terminal 52 (which is in turn coupled to the high voltage lead of secondary winding 30) disposed in a blind bore portion formed in a lowermost end of spool 28. Contact spring 68 is configured to engage a high-voltage connector terminal of spark plug 14. This arrangement for coupling the high voltage developed by secondary winding 30 to plug 14 is exemplary only; a number of alternative connector arrangements, particularly spring-biased arrangements, are known in the art.

A release layer 24 provides a mechanism that demotes adhesion of encapsulant in favor of adhesion of the encapsulant to the inside surface of secondary winding spool 28. During thermal cycling, the stresses are unidirectional and substantially uniform. Cracking or other breakdown of the secondary winding spool is reduced.

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

1. An ignition apparatus comprising:
a central core of magnetically-permeable material having a main axis;
a primary winding radially outwardly of said core;
a release material radially outwardly of said primary winding and in contact therewith;
a secondary winding spool radially outwardly of said release material having a secondary winding wound thereon;
a case outwardly of said spool; and
a shield of magnetically-permeable material outwardly of said case, wherein said release material is configured to demote adhesion of an encapsulant disposed between said release material and an inside surface of said spool.

2. The ignition apparatus of claim 1 wherein said release material comprises one of a P.T.F.E. material, a polyamide material, a polyester material and a silicone rubber material.

3. The ignition apparatus of claim 2 wherein said P.T.F.E. material comprises PTFE tape.

4. The ignition apparatus of claim 3 wherein said release material comprises one layer of PTFE tape.

5. The ignition apparatus of claim 1 wherein said encapsulant comprises epoxy potting material.

6. An ignition apparatus comprising:
a central core of magnetically-permeable material having a main axis;
a primary winding radially outwardly of said core;
a release material radially outwardly of said primary winding and in contact therewith;
a secondary winding spool radially outwardly of said release material having a secondary winding wound thereon;
a case outwardly of said spool; and
a shield of magnetically-permeable material outwardly of said case, wherein said release material is configured to demote adhesion of an epoxy material disposed between said release material and an inside diameter of said spool.

7. A method of making an ignition apparatus comprising the step of applying a release material over a primary winding configured to demote adhesion of an encapsulant disposed intermediate the release material and a secondary winding spool.

8. The method of claim 7 further including the steps of:
introducing the encapsulant into an annular potting channel defined between the release material and an inside diameter surface of the secondary winding spool; and
curing the encapsulant, wherein the encapsulant shrinks radially outwardly away from the release material.
